(19) United States
(12) Patent Application Publication
(10) Pub. No.: US 2006/0187192 A1
(43) Pub. Date: Aug. 24, 2006

(54) Control unit, in particular for medical equipment

(76) Inventors: Robert Kagermeier, Nurnberg (DE); Donal Medlar, Weisendorf (DE)

Correspondence Address: Brinks Hofer Gilson & Lione, P O Box 10395, Chicago, IL, 60610, US

(21) Appl. No.: 10/566,942

(22) PCT Filed: Jul. 14, 2004
(86) PCT No.: PCT/EP04/07804

§ 371 Date: Jan. 31, 2006

(30) Foreign Application Priority Data
Aug. 7, 2003 (DE) 10336276.2

(51) Int. Cl. G09G 5/00

(52) U.S. Cl. 345/156

(57) ABSTRACT

The invention relates to a control unit, in particular for medical equipment. Said unit comprises a display surface (5) that can be sterilised, a protective housing (3) that can be sterilised and is mechanically connected to the display surface (5) and a recording unit (4) that can be inserted into the protective housing (3) and comprises a detection device (7), which is used to identify a modification in the position of an object relative to the display surface (5). The recording unit (4) is switched on by acoustic activation via a voice input, or alternatively by means of a proximity switch (14) when an object approaches the projection plate (5).

### BACKGROUND

The present embodiments relate to a control unit, in particular for medical equipment, such as an X-ray device.

A user control device provided for triggering a medical device is known for instance from U.S. Pat. No. 5,959,557, in the form of a handheld control device that can be sterilized in an autoclave. This control device is connected by a cord to the equipment to be triggered, but it is also supposed to be usable with infrared data transmission, for instance. Because of the electronic components of a wireless control unit, major restrictions are made on the control unit, such as a restriction on the allowable temperature load, compared to a control unit with a cord that has simple mechanical switches and/or buttons. In a control unit with a cord, on the other hand, the cord itself is a potential weak point in a working area that must be kept sterile.

For operating medical and industrial equipment, among other uses, an optical detection device known from German Patent Disclosure DE 195 39 955 A1 is provided. Here, a monitored area monitored by the optical detection device can have a size approximately equivalent to the size of a presentation panel, for instance in the form of a 10″×20″ monitor. The specific requirements of medical technology are not addressed in DE 195 39 955 A1.

From German Patent Disclosure DE 41 21 180 A1, a screen can be found, particularly for a navigation system, with proximity sensors that operate in two stages. The screen is embodied on the order of a touch screen and has user control elements which are not incorporated until the first stage of the proximity switch is activated, or in other words until a user control stylus or a finger is brought to the screen. The various elements are then activated in the second stage.

If vulnerable input devices such as a control panel with a film keyboard or a monochrome or color display with a touch-sensitive so-called touch film are used in a sterile working area for controlling a medical device, then such input devices, because they cannot be sterilized, are typically covered with sterile cloths or packed in sterile bags. This makes their use considerably more difficult and especially impairs the legibility of display devices as part of the input device.

### BRIEF SUMMARY

A control unit that is simple to sterilize is especially suitable for medical applications and can be used flexibly.

A control unit has both a display surface and a protective housing mechanically connected to the display surface as sterilizable parts. Both the display surface and the protective housing have no electronic components that would limit the capability of sterilization. The protective housing is intended for reversibly receiving a recording unit, whose function is adapted to the display surface. To that end, a detection device is provided as part of the recording unit, for detecting a change in the positioning of an object, such as a pointer or a finger of a user, relative to the display surface.

The recording unit is easily removable from the protective housing and in operation of the control unit is completely enclosed in the protective housing. The detection device, which functions in contactless fashion, is effective through the wall of the protective housing. Because the recording unit is enclosed in the protective housing, it suffices for the recording unit, as part of the control unit that is to be used in a sterile working area, to be merely disinfected, rather than sterilized. Handling the recording unit in an autoclave is not required. Conversely, the other parts of the control unit are sterilizable as often as desired, for instance by means of temperature, gas, and/or radiation, without impairing their functionality. They are furthermore extremely resistant to damage caused by being dropped. To make especially energy-saving operation possible, particularly of the control unit that has a projection device, the control unit preferably has a proximity switch, which switches the projection device on only if an object approaches the projection screen. When the object moves away from the projection screen, the projection device is switched off again, such as in a delayed fashion. In addition or as alternative to the optically controlled switching on of the projection device, the projection device is activated by voice input. Thus, a further enhancement of the ease of use is achieved with simultaneously energy-saving operation. A voice input capability is also contemplated in embodiments without a projection device.

In a first embodiment, as the display surface, a permanently labeled or otherwise permanently identified surface, for instance embossed, is provided, such as in the form of a plastic or metal plate. The display surface can thus, in cooperation with the detection device, take on the function of a keypad or a keyboard with fixed key assignments.

In a second embodiment, the display surface is embodied as a projection screen, and the recording unit is embodied as a projection/detection unit. A projection device that is part of the projection/detection unit reproduces a user surface on the projection screen. With the user surface projected onto the projection screen, a so-called virtual keyboard is created, which unlike the first embodiment is distinguished by arbitrary variability. The protective housing has a window that is sufficiently permeable to the radiation of the projection device, so that the entire projection/detection unit can be enclosed in the protective housing. The advantages named in conjunction with the first embodiment in terms of sterilizability apply to the second embodiment as well.

The detection device, which for instance detects the approach of a user's hand or finger to the projection screen, functions for instance as a so-called gesture input system, which evaluates images taken by a video camera. In an alternative, however, a radiation source, in particular an infrared radiation source that is not perceptible to the user, is provided, which makes it possible to scan defined volumetric and/or surface regions, and in particular a surface spaced apart parallel from the projection screen. The radiation source is combined with the detection device and optionally with the projection device into a structural unit, and contactless spacing measurement is realized by means of laser spacing sensors.

A transmission unit is also provided, for establishing wireless data communication between the control unit and the equipment to be triggered. The transmission unit is likewise integrated with the recording unit, in particular the projection/detection unit. In addition or as an alternative, non-wireless data transmission between the control unit and the equipment to be triggered, such as X-ray equipment, is possible.

In one refinement, the control unit has a device base, with which the display surface, embodied particularly as a projection screen, and the protective housing, including the recording unit preferably embodied as a projection/detection unit, are pivotably connected. The lightweight construction, compared to a display-based panel such as a touch screen, makes it possible to embody the base of the device as a magnetic base, which can be secured to an arbitrary ferromagnetic structural part, in particular a wall of the equipment. This makes optimal flexibility in positioning the control unit possible. Moreover, the function of the magnetic base is unimpaired by any sterile coverings on the equipment wall.

The energy supply to the control unit is preferably furnished by a rechargeable battery. This battery may for instance be part of the projection/detection unit or may optionally be located in the device base. Particularly when the battery is located in the device base, an energy transmission module for wireless and in particular inductive energy transmission to the recording unit is provided. To that end, equipment on whose housing the magnetic base can be secured is equipped with a suitable power supply unit. In addition to the inductive energy transmission, an inductive data transmission is also contemplated.

Because the control unit can easily be broken down into the components that are accessible from outside, in particular the projection screen on the one hand and the electronic components, in particular the projection, evaluation and transmission devices, located in protected fashion in a housing on the other, easy sterilizability exists of the solely passive components that are accessible in operation of the control unit. Moreover, because additional sterile coverings are dispensed with, good legibility and ease of use of the user control elements are assured.

### BRIEF DESCRIPTION OF THE DRAWINGS

One exemplary embodiment is described in further detail below in conjunction with a drawing. The sole drawing figure schematically shows a control unit of a medical device.

### DETAILED DESCRIPTION OF THE DRAWINGS AND THE PRESENTLY PREFERRED EMBODIMENTS

A control unit 1 shown symbolically in the drawing is intended for triggering a piece of interventional medical diagnostic and/or therapy equipment, such as a movable C-arc X-ray system, an angiography system, or a urology/lithotripsy device. When this kind of medical equipment (not shown) is used, the necessity occurs of making an input unit available to the user in the sterile area, for inputting data close to the patient, such as for movements of the equipment or other equipment functions. The input device should also make data output possible, or in other words should have a display function.

Both the display and the input function are realized in the exemplary embodiment by means of a user control surface 2 of the control unit 1. The user control surface 2 is embodied on the order of a virtual keyboard. A projection/detection unit 4, located in a protective housing 3, cooperates with a projection screen 5, which has a coating with a highly reflective surface. The projection/detection unit 4 is referred to in general as a recording unit and the projection screen 5 as a display surface. Both the protective housing 3 and the projection screen 5 mechanically connected to it are passive components of the control unit 1. The projection/detection unit 4, as an active component, includes a projection device 6 that projects visible light onto the projection screen 5, a detection device 7, and a radiation source 8, namely an infrared radiation source that emits in the non-visible spectral range.

The components of the projection/detection unit 4 are completely enclosed in the protective housing 3 during operation of the control unit 1, and the protective housing 3 suitably has radiation-permeable windows. The projection device 6 generates the user control surface 2, which is visible to the user, on the projection screen 5, and the user control surface is variable, for adapting it to different types or stages of examination, for instance with different menus, Tab Cards or in some other way. The projection device 6 uses red laser light, for instance, but a multicolor display on the projection screen 5 can also be realized. In the exemplary embodiment, only eight function areas F1 through F8 are shown.

The detection device 7 detects the position of an object, such as a pointer or a finger of the user, relative to the projection screen 5. Cooperating with the detection device 7 is the radiation source 8, which functions in the non-visible spectral range and/or non-optically and emits in a plane that is a few millimeters, for instance approximately 2 mm to 20 mm, above the projection screen 5 and parallel to it. Hence, the detection device 7 already responds when object approaches the projection screen 5 even if the object does not touch the projection screen 5.

In comparison to a conventional display-based user control panel, the projection screen 5 is very lightweight. Covering or encasing the projection screen 5 is unnecessary, since the projection screen can be sterilized in a typical autoclave. Together with the projection screen 5, the protective housing 3 is also sterilized in the same way. The projection/detection unit 4, which in comparison to the passive components, that is, the projection screen 5 and the protective housing 3, has comparatively vulnerable components, is conversely not intended for sterilization in an autoclave. For the projection/detection unit 4 disposed in the protective housing 3, disinfection, in which the demands in terms of killing microbes are less stringent than for sterilization, is sufficient despite the fact that the control unit 1 is used in a sterile area.

The demands in terms of mechanical stability of the projection screen 5 are low, compared to an input unit such as a film keyboard or a touch-sensitive touch panel, which requires the exertion of a user control force. If the projection screen 5 happens not to be in sterilized form, for instance during an emergency use, then covering or encasing the projection screen 5 with a sterile cloth or a sterile bag is still easily possible, and in that case despite the necessary decrease in the reproduction quality of the user control surface 2, the control unit 1 can still be used.

Together with the projection/detection unit 4 of compact construction, the control unit 1 in its entirety is thus constructed in a very weight-saving way. For mounting the control and display unit 9, which includes both the projection/detection unit 4 and the projection screen 5, a magnetic base 10 is thus especially well suited as a device base for the control unit 1.

The control/display unit 9 is pivotably connected to the magnetic base 10 by means of an adjustable gooseneck fastening 11. As an alternative, pivotably connecting it by means of a ball joint is also possible. The magnetic base 10 can be secured to an arbitrary ferromagnetic surface, for instance of an image enhancer or of a patient table. A sufficiently stable fastening exists even if the metal surface is covered with a sterile cloth.

An energy transmission module 12 is located in the magnetic base 10 and is intended for inductive energy transmission between the equipment to which the control unit 1 is secured and the projection/detection unit 4. A corresponding power supply unit outside the control unit 1 and a rechargeable battery in the control unit 1 are not shown. In addition to the energy transmission to the magnetic base 10, a transmission of information to and/or from the magnetic base 10 can also be contemplated in a similar way.

In addition to the projection/detection unit 4, a radio module 13 is located in the protective housing 3 as a transmission unit, for establishing the communication between the control unit 1 and the equipment to be triggered. Alternatively, an infrared transmission module is equally usable, although the radio module 13 has advantages over it in terms of range. The electronic components are constructed as a compact structural unit inside the protective housing 3 and are supported in a mechanically damped way and thus protected against damage even if the control unit 1 is dropped.

A proximity switch 14, which is preferably integrated in the detection device 7, is also located in the protective housing 3. This proximity switch switches the projection device 6 on in a mode of operation solely when an object approaches the user control surface 2. Thus overall, a very energy-saving operation of the control unit 1 is provided, which thus makes a long operation time possible even with low battery capacity. The low battery capacity, particularly compared to a display-based radio user control system, moreover makes a further substantial contribution to a weight-saving embodiment of the control unit 1.

1. A control unit comprising
a sterilizable screen which is free of electronic components and on which a user control field is reproducable,
a detection device for detecting a change in a position of an object relative to the screen, and
a sterilizable protective housing connected mechanically to the screen, the protective housing being free of electronic components and operable for reversible reception of the detection device,
wherein for switching on the detection device, a device for acoustic activation by voice input is provided.

2. The control unit of claim 1, in which the screen is a projection screen and the the detection device comprises a projection/detection unit, which includes a projection device for projecting the user control field onto the projection screen.

3. A control unit comprising
a sterilizable screen which is free of electronic components and on which a user control field is reproducable,
a detection device for detecting a change in a position of an object relative to the screen,
a sterilizable protective housing connected mechanically to the screen, the protective housing being free of electronic components and operable for reversible reception of the detection device,
wherein the detection device is a projection/detection unit having a projection device for projecting the user control field onto the projection screen, and
a proximity switch for switching on the projection/detection unit upon the approach of an object to the projection screen.

4. The control unit of claim 1, further comprising a radiation source cooperating with the detection device.

5. The control unit of claim 4, wherein the radiation source comprises an infrared radiation source.

6. The control unit of claim 1, further comprising a transmission unit for wireless communication with a medical device to be triggered.

7. The control unit of claim 1, further comprising a device base pivotably connected to the screen.

8. The control unit of claim 7, wherein the device base comprises a magnetic base.

9. The control unit of claim 1, further comprising an energy transmission module for wireless energy transmission to the detection device.

10. The control unit of claim 2 wherein the projection device comprises a radiation source cooperating with the detection device.

11. The control unit of claim 3 further comprising a radiation source cooperating with the detection device.

12. The control unit of 11 further comprising a transmission unit for wireless communication with a medical device to be triggered in response to the detection device.

13. The control unit of claim 3 further comprising a transmission unit for wireless communication with a medical device to be triggered in response to the detection device.

14. The control unit of claim 3, further comprising a device base pivotably connected to the screen.

15. The control unit of claim 13, wherein the device base comprises a magnetic base.

16. The control unit of claim 3, further comprising an energy transmission module for wireless energy transmission to the detection device.

17. The control unit of claim 4 further comprising a transmission unit for wireless communication with a medical device to be triggered in response to the detection device.

18. The control unit of claim 2 further comprising a transmission unit for wireless communication with a medical device to be triggered in response to the detection device.
